(19) United States
(12) Patent Application Publication
(10) Pub. No.: US 2026/0172303 A1
(43) Pub. Date: Jun. 18, 2026

(54) Device Component Failure Prediction

(71) Applicant: Arista Networks, Inc., Santa Clara, CA (US)

(72) Inventors: Brendan Murray, Maynooth (IE); Vlad Serban Hanciuta, Dublin (IE)

(21) Appl. No.: 18/984,786

(22) Filed: Dec. 17, 2024

(51) Int. Cl. H04L 41/0654; H04L 41/147

(52) U.S. Cl. CPC H04L 41/0654; H04L 41/147

(57) ABSTRACT

A component failure prediction system may include memory circuitry and processing circuitry coupled to memory circuitry. The processing circuitry may obtain historical measurement data for each of a plurality of device components that are of the same component type, determine degradation of each of the plurality of device components based on the historical measurement data, identify a given device component of the plurality of device components based on the degradation of the given network device component deviating from a natural degradation indicated by the degradation of at least some of the plurality of device components, and mitigate an expected failure of the given device component.

### BACKGROUND

Devices such as network devices include components that can fail after operating for a period of time. The failure of a component can be disruptive to the operations of the system in which the device operates. The determination of the component failure, the replacement of the failed component, and/or other remediation operations are often reactive, taking place after component failure or at undesired or inconvenient times. This can present operational challenges to system operators and prolong the disruption caused by failed components. Accordingly, it may be desirable to proactively determine the operational status of device components.

### BRIEF DESCRIPTION OF THE DRAWINGS

FIG. 1 is a diagram of an illustrative component failure prediction system communicatively coupled to network device(s) in accordance with some embodiments.

FIG. 2 is a diagram of an illustrative network device and illustrative server equipment implementing a component failure prediction system in accordance with some embodiments.

FIG. 3 is a flowchart of illustrative operations for proactively addressing expected component failure in accordance with some embodiments.

FIG. 4 is a flowchart of illustrative operations for determining device component degradation and expected component failure in accordance with some embodiments.

FIG. 5 shows illustrative graphs of component operating parameters and corresponding component degradation data derived based on the operating parameters in accordance with some embodiments.

FIG. 6 is an illustrative graph of component degradation for a failing component in accordance with some embodiments.

FIG. 7 is an illustrative graph of component degradation for a failing component characterized by long-term behavior(s), medium-term behavior(s), and short-term behavior(s) in accordance with some embodiments.

FIG. 8 shows a table of illustrative regression parameter values and weights used to generate a degradation score in accordance with some embodiments.

FIG. 9 is an illustrative histogram of components with corresponding degradation scores in accordance with some embodiments.

### DETAILED DESCRIPTION

A network device may include multiple components. In illustrative configurations described herein as examples, these components can include optical transceiver(s). An optical transceiver (e.g., light source(s) therein) may fail after operating for a period of time. While this failure may be identified and the failed optical transceiver may be replaced, this process can take some time, leading to the networking system (in which the network device operates) having to operate in a suboptimal manner for a prolonged period of time. Accordingly, it may be desired to proactively determine the expected failure of components and to proactively order replacements for or otherwise mitigate the expected failure of the components, thereby reducing system disruption due to failed components (e.g., in comparison to reactively replacing failed components).

In one illustrative configuration described herein as an example, a component failure prediction system may include processing circuitry that obtains historical measurement data for operating parameters, such as transmit optical power and transmit bias current, for optical transceivers. The processing circuitry may determine the degradation of the optical transceiver by (pre-)processing the historical measurement data and analyzing the pre-processed measurement data over different time scales, e.g., thereby characterizing long-term degradation behavior, medium-term degradation behavior, short-term degradation behavior, etc. Based on the determined degradation of the optical transceiver deviating from a natural degradation of optical transceivers of the same type, the processing circuitry may mitigate the expected optical transceiver failure (e.g., issue a notification indicative of the expected optical transceiver failure). This example is merely illustrative. Additional details for component failure prediction and mitigation are further described herein.

While optical transceivers are sometimes described herein to be the components for which failure is predicted and for which mitigation is performed based on their anticipated failure, these examples are merely illustrative. If desired, the historical measurement data of other network device components, or more generally other electronic device components, may be used to predict failure of these other types of components in an analogous manner as described herein for optical transceivers, and corresponding mitigation of these other types of components can be performed.

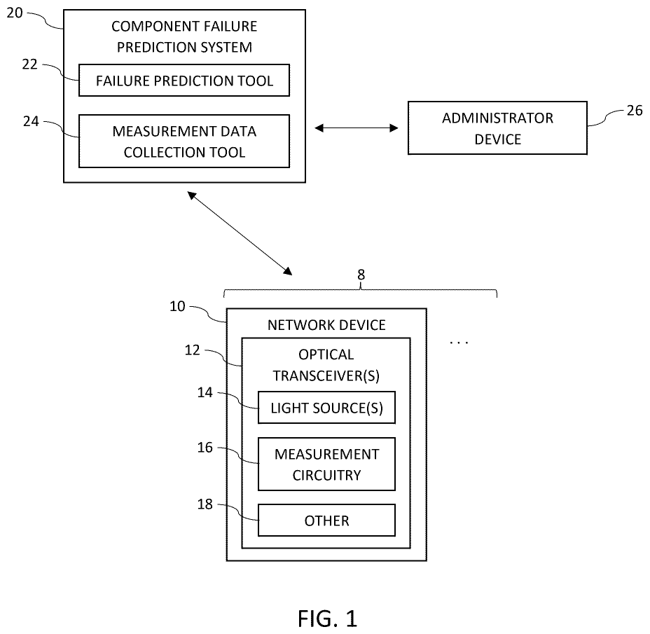

FIG. 1 shows an illustrative system for which a component failure detection system is provided. In the example of FIG. 1, the system may include one or more components of a network such as network 8. Network 8 may have any suitable scope. As examples, network 8 may include, be, and/or form part of one or more local segments, one or more local area networks (LANs), one or more virtual local area networks (VLANs), one or more local subnets, one or more data center networks, one or more campus area networks, one or more wide area networks, etc. If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices that handle (e.g., process by switching, routing, forwarding, modifying, etc.) network traffic to convey information for user applications between end hosts and/or for other applications, services, and functions generally between devices (e.g., network devices and/or end host devices). Network 8 may include networking equipment forming a variety of network devices that interconnect end hosts of network 8. As examples, network devices of network 8 may include one or more wireless access points, one or more switches (e.g., single-layer (Layer 2) switches, multi-layer (Layer 2 and Layer 3) switches, etc.), one or more bridges, one or more routers, one or more gateways, one or more hubs, one or more repeaters, one or more firewalls, one or more devices serving other networking functions, one or more devices that include the functionality of two or more of these devices, and/or management equipment that manages and controls the operation of one or more other network devices. One such network device of network 8, network device 10, is shown in the example of FIG. 1.

Network device 10 may include components that are susceptible to failure, such as one or more optical transceivers 12 used to convey optical signals between network device 10 and external equipment (e.g., another network device in network 8, an end host of network 8, etc.). An optical transceiver 12 may include one or more light sources 14 (e.g., lasers, light-emitting diodes, etc.) or other active device elements, such as an optical amplifier, that each provide an optical signal (e.g., characterized by and having a transmit power) based on a received electrical signal (e.g., characterized by and having a bias current). The optical signal may convey data or information to the external equipment.

To monitor the operation of optical transceiver 12, optical transceiver 12 may include measurement circuitry 16 (sometimes referred to as monitoring circuitry 16) that measures different operating parameters of optical transceiver 12 such as operating voltage, operating temperature, transmit optical power (e.g., optical power transmitted by light sources of different lanes or channels), transmit bias current (e.g., received by light sources of different lanes or channels), receive optical power (e.g., optical power received by photodetectors of different lanes or channels), etc., and generate corresponding optical transceiver measurement data on these parameters. As an example, various types of sensors (e.g., voltage sensors, temperature sensors, optical sensors, power sensors, etc.) may be coupled to the components of transceiver 12 to gather the measurement data on the different parameters.

While not separately shown in the example of FIG. 1, other components 18 may be included in optical transceiver 12. As examples, other components 18 may include driver circuitry for light source(s) 14, amplifier circuitry, bias circuitry, power management circuitry, optical signal detector circuitry (e.g., photodetectors forming the optical receiver portion of transceiver 12), and/or other circuitry that support the operations of transmission and/or reception of optical signals.

As shown in FIG. 1, an illustrative component failure prediction system 20 may be communicatively coupled to one or more network devices of network 8 such as network device 10 having optical transceiver 12. Component failure prediction system 20 may include a component failure prediction tool 22 (e.g., implemented as one or more applications or services executing on computing equipment) and a measurement data collection tool 24 (e.g., implemented as one or more applications or services executing on computing equipment). Collection tool 24 may collect (e.g., aggregate) measurement data, such as optical transceiver measurement data (e.g., generated by respective measurement circuitry 16), from one or more sources, and/or may process (e.g., organize, re-format, etc.) and maintain the aggregated measurement data. As examples, collection tool 24 may receive optical transceiver measurement data from network devices in network 8 (e.g., in real-time), from network devices in different networks (e.g., different networks belonging to different entities, users, etc.), from one or more databases of optical transceiver measurement data (e.g., maintained by other dedicated data collection systems), etc.

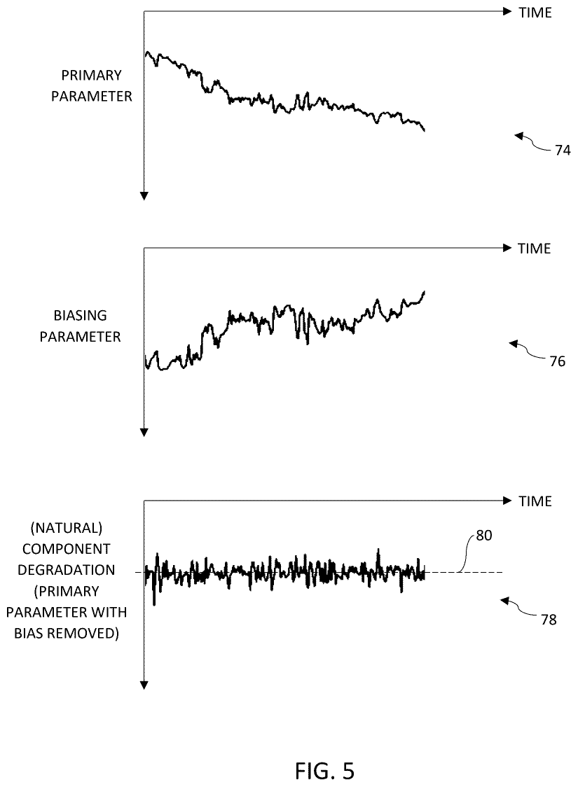

The measurement data obtained by collection tool 24 may be historical measurement data (e.g., historical measurement data on operating parameters for different optical transceivers) that include values of each operating parameter collected over time. The historical measurement data for each component may begin at the same relative time in the component lifecycle (e.g., begin at a time when that particular component is first operational). While historical measurement data for different components of the same type can be obtained at different times, historical measurement data for these components may be processed relative to each other based on their days in operation. Accordingly, sometimes time as described herein (e.g., in connection with the graphs of FIGS. 5-7) may refer to a number of days a given component has been in operation, rather than the absolute time at which the measurement data value is generated.

A component failure prediction tool 22 may, based on the historical measurement data obtained by collection tool 24, identify device components expected or anticipated to fail (e.g., already exhibiting degraded performance, has a high likelihood of failure within a particular period of time, etc.).

In illustrative configurations sometimes described herein as an example, component failure prediction tool 22 may organize the historical measurement data on a per-component-type basis and identify one or more faulty components of a given type based on an analysis performed using the historical measurement data for all components of the same type as the faulty component(s).

In illustrative configurations in which prediction tool 22 performs failure prediction for optical transceivers, prediction tool 22 may perform separate failure prediction operations for each optical transceiver type (e.g., each model or stock keeping unit (SKU) of optical transceivers, each class or group of optical transceivers including similar models, etc.). In other words, a failure prediction operation may be used to predict failure of optical transceivers having the same package type (e.g., small formfactor pluggable (SFP), quad small form factor pluggable (QSFP), quad small form factor pluggable double density (QSFP-DD), octal small form-factor pluggable (OSFP), etc.), having the same (single-lane and/or multi-lane) data rates (e.g., 10 Gigabits per second (Gbps), 25 Gbps, 40 Gbps, 100 Gpbs, etc.), having the same optical (fiber) connector type, having the same light source type, and/or having other same characteristic(s).

As an example, as part of the failure prediction operation, failure prediction tool 20 may generate, for each device component, a degradation score indicative of a degree of component degradation and/or a likelihood of failure (e.g., within a predetermined time period).

Based on the score exceeding a threshold (and/or other criteria being met), prediction tool 22 may perform one or more mitigation operations. In an illustrative configuration described herein as one example of a mitigation operation, prediction tool 22 may provide and output an indication of expected component failure, e.g., as a notification, to external equipment. In the example of FIG. 1, an administrator device 26 (e.g., a computing device such as a laptop, a computer, etc., operated by a network administrator or user) may be communicatively coupled to system 20 (e.g., to prediction tool 22). The notification may be transmitted to administrator device 26. If desired, the mitigation operation may include logging or storage of the indication of component failure and other component failure information (e.g., estimated time for component failure, component type, component location, component measurement data, etc.), instead of or in addition to the output of such information (e.g., in the notification to external equipment such as device 26). If desired, manual inspection of the results of failure prediction tool 22 (e.g., over a web browser application or other interface provided by system 20) may be facilitated to allow for viewing of the prediction of expected component failure and other component failure information, as another example of a mitigation operation.

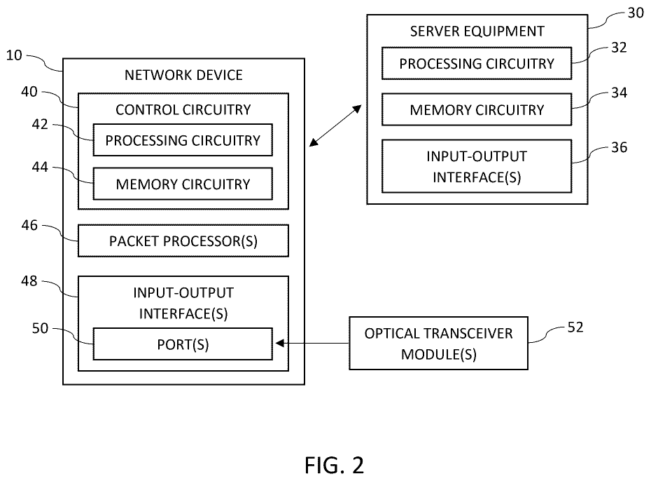

FIG. 2 is a diagram of an illustrative implementation of the elements in FIG. 1. In the example of FIG. 2, server equipment 30 may be used to implement at least a portion of system 20 in FIG. 1 (e.g., component failure prediction tool 22 and/or measurement data collection tool 24). Server equipment 30 may include server hardware such as one or more blade servers, one or more rack servers, and/or one or more tower servers. Compute devices and storage devices for implementing the functions of the server may be provided as part of the server hardware and may be communicatively coupled to each other. The compute devices, forming processing circuitry 32 of server equipment 30, may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors. The storage devices, forming memory circuitry 34 of server equipment 30, may include non-volatile memory circuitry (e.g., solid-state drives, flash memories or other electrically-programmable read-only memories, hard disk drive storage devices, etc.), volatile memory circuitry (e.g., static or dynamic random-access memories), and/or other storage circuitry.

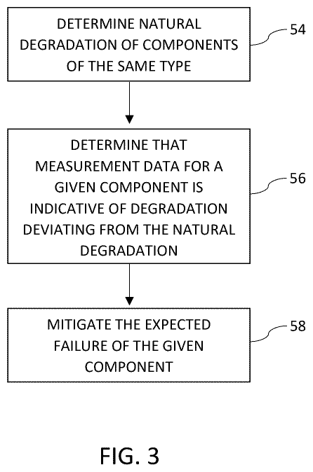

Accordingly, memory circuitry 34 may include one or more non-transitory (tangible) computer-readable storage media that store the operating system software and/or any other software code. Processing circuitry 32 may run (e.g., execute) an operating system and/or other software (including firmware) stored on the one or more non-transitory computer-readable storage media to perform the desired operations of the server (e.g., to perform the operations described in connection with component failure prediction system 20, to perform the operations described in connection with FIGS. 3-9, etc.). As examples, processing circuitry 32 may perform the operations described herein in connection with, and thereby implement, prediction tool 22 by executing corresponding (software) instructions stored on memory circuitry 34 and/or perform the operations described herein in connection with, and thereby implement, collection tool 24 by executing corresponding (software) instructions stored on memory circuitry 34. Accordingly, the operations described in connection with system 20 and tools 22 and 24 may generally be described herein as being performed by processing circuitry (e.g., processing circuitry 32, or if desired, non-server-based processing circuitry).

Server equipment 30 may also include input-output components (e.g., wireless communication circuitry, wired communication circuitry, interface circuitry, and/or other circuitry) that provide input-output interfaces 36 to facilitate connectivity with network device 10, other network devices in network 8 (FIG. 1), administrator device 26 (FIG. 1), and/or other external equipment.

Server equipment 30 may be communicatively coupled to network devices of network 8 such as network device 10 in FIG. 1. As shown in FIG. 2, network device 10 (e.g., device 10 in FIG. 1) may include control circuitry 40 having processing circuitry 42 and memory circuitry 44, one or more packet processors 46, and input-output interfaces 48. In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). If desired, in another illustrative arrangement, network device 10 may be a fixed-configuration network device (e.g., a fixed-configuration switch having a fixed number of ports and/or a fixed hardware configuration).

Processing circuitry 42 may include one or more processors of any suitable processor architecture. Processing circuitry 42 may run (e.g., execute) a network device operating system and/or other software (including firmware) that is stored on memory circuitry 44. Memory circuitry 44 may include one or more non-transitory (tangible) computer-readable storage media that store the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 44). The corresponding processing circuitry (e.g., one or more processors of processing circuitry 42) may execute the respective instructions to perform the corresponding operations. Memory circuitry 44 may include non-volatile memory circuitry, volatile memory circuitry, and/or other storage circuitry. Processing circuitry 42 and (at least some portions of) memory circuitry 44 as described above may sometimes be referred to collectively as control circuitry 40 (e.g., implementing a control plane of network device 10).

Packet processor(s) 46 may be used to implement a data plane or forwarding plane of network device 10. Packet processor(s) 46 may include one or more processors of any suitable processor architecture. A packet processor 46 may receive incoming network packets via input-output interfaces 48 (and/or via device internal interfaces), parse and analyze the received network packets, process the packets based on packet forwarding decision data and/or in accordance with network protocol(s) or other traffic policy, and forward (or drop) the network packet accordingly.

To interact and communicate with external devices, external systems, and/or users, network device 10 may include input-output interfaces 48 formed from corresponding input-output devices (sometimes referred to as input-output circuitry or interface circuitry). Input-output interfaces 48 may include different types of communication interfaces such as Ethernet interfaces (e.g., formed from one or more Ethernet ports), optical interfaces (e.g., formed from optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, administrator devices, etc.).

As an example, some input-output interfaces 48 (e.g., those based on wired communication) may be formed from physical ports 50. These physical ports may be configured to physically couple to and/or electrically connect to corresponding mating connectors of external components such as pluggable optical transceiver modules 52. Illustrative configurations in which optical transceivers 12 (FIG. 1) are implemented on optical transceiver modules 52 are sometimes described herein as an example. In this example, processing circuitry 32 of server equipment 30 (e.g., implementing system 20 in FIG. 1) may obtain, from network device 10, historical measurement data of optical transceiver 12 (e.g., from measurement circuitry 16 therein) implemented within modules 52 and may determine an expected failure of module 52 (e.g., an optical transceiver therein) based on the type of module 52 and the historical measurement data of module 52.

FIG. 3 is a flowchart of illustrative operations for handling component failure in a proactive manner. In particular, these operations may be performed by one or more processors of server equipment 30 (e.g., processing circuitry 32 in FIG. 2) using other components of server equipment 30 (e.g., memory circuitry 34, interfaces 36, etc., in FIG. 2). In some configurations described herein as an illustrative example, at least some of the operations described in connection with FIG. 3 may be performed by one or more processors (e.g., of processing circuitry 32) executing software instructions stored on memory circuitry (e.g., one or more non-transitory computer-readable storage media of memory circuitry 34). If desired, one or more operations described in connection with FIG. 3 may be performed by other types of computing equipment (e.g., non-server computing equipment).

At block 54, processing circuitry (e.g., one or more processors on which system 20 and/or prediction tool 22 are executed, processing circuitry 32 of server equipment 30, etc.) may determine a natural degradation of components of same type (e.g., the same type of optical transceivers 12, the same type of optical transceiver modules 52, etc.). In particular, components of the same type tend to degrade in a normal or natural manner over their lifetimes. This natural degradation (sometimes referred to as a baseline degradation) may be obtained based on observed historical measurement data values of one or more operating parameters exhibited over time and may be represented by a range of acceptable values or other conditions that serve as indication(s) of this natural degradation.

At block 56, the processing circuitry may determine that historical measurement data for a given component of the same type (e.g., a given optical transceiver 12 or module 52 of the same type) is indicative of degradation deviating from the natural degradation. In particular, a given component exhibiting degradation represented by a value outside of the range of values may be indicative of the degradation of the given component deviating (e.g., exceeding) the natural degradation determined at block 54.

At block 58, the processing circuitry may mitigate the expected failure of the given component. As sometimes described herein, mitigation of an expected failure of a component may include operations that indirectly bring about the reduction of adverse effects or resolution of the expected failure of the component (e.g., notification to a user such that the user can directly address and resolve the expected failure, maintaining or storage of expected failure information for access by a user such that the user can directly address and resolve the expected failure, conveyance of an error signal to a control circuit of the component such that the control circuit can directly address and resolve the expected failure, etc.) and/or operations that directly address and resolve the expected failure of the component (e.g., the processing circuitry directly addressing the expected failure such as by disabling the component, adjusting the operation of the component to compensate for the expected failure, activating a backup component, etc.). In the context of degradation and expected failure of optical transceivers, the use of indirect techniques for mitigation are sometimes described herein as examples. Accordingly, as some more specific examples of mitigation, the processing circuitry may generate, store, and/or output an indication of the expected component failure, information indicative of expected component failure (e.g., information resulting from the analysis of the historical measurement data of the component to determine its expected failure), information identifying the component expected to fail (e.g., a component type, a component location, etc.), indications of further actions to be taken by an external entity (e.g., by external equipment, by a network administrator) in response to the expected failure (e.g., an indication to examine the given component, an indication to order a replacement for the given component, etc.), and/or other information for mitigating the expected failure.

In one illustrative configuration, the processing circuitry may provide, in a notification to external equipment (e.g., administrator device 26 in FIG. 1), an indication of a given optical transceiver 12 or optical module 52 expecting to fail and information generated at blocks 54 and 56 causing the failure prediction for the given optical transceiver 12 or optical module 52. The processing circuitry may store the information generated at blocks 54 and 56 (e.g., on memory circuitry 34 in FIG. 2) for access by the external equipment (e.g., after receiving the notification).

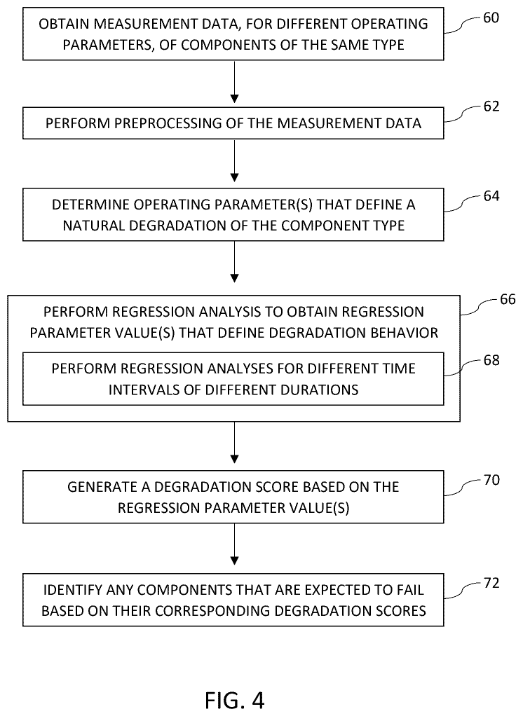

Various manners for determining component degradation may be performed by the processing circuitry in connection with blocks 54 and 56 of FIG. 3. As an example, FIG. 4 provides an illustrative manner for determining (e.g., characterizing) component degradation. In particular, FIG. 4 shows a flowchart of illustrative operations for characterizing component degradation and identifying components expected to fail based on their degradation.

In particular, these operations of FIG. 4 may be performed by one or more processors of server equipment 30 (e.g., processing circuitry 32 in FIG. 2) using other components of server equipment 30 (e.g., memory circuitry 34, interfaces 36, etc., in FIG. 2). In some configurations described herein as an illustrative example, at least some of the operations described in connection with FIG. 4 may be performed by one or more processors (e.g., of processing circuitry 32) executing software instructions stored on memory circuitry (e.g., one or more non-transitory computer-readable storage media of memory circuitry 34). If desired, one or more operations described in connection with FIG. 4 may be performed by other types of computing equipment (e.g., non-server computing equipment).

At block 60, processing circuitry (e.g., one or more processors on which system 20, and/or prediction tool 20 are executed, processing circuitry 32 of server equipment 30, etc.) may obtain historical measurement data, for different operating parameters, of a set of components of the same type. As examples, the processing circuitry (e.g., when implementing prediction tool 22) may obtain the historical measurement data from memory circuitry (e.g., memory circuitry 34) maintained by collection tool 24, may obtain the historical measurement data from network devices directly, and/or may obtain the historical measurement data in other manners (e.g., from other databases or stores of the historical measurement data on component operating parameters).

In illustrative configurations in which the set of components of the same type are optical transceiver(s) of the same type as optical transceiver 12 in FIG. 1 (e.g., the set of components of the same type are optical transceiver modules of the same type as optical transceiver modules 52 in FIG. 2), the different operating parameters for which historical measurement data is obtained may include operating voltage, operating temperature, transmit optical power (e.g., optical power transmitted by light sources of different lanes or channels), transmit bias current (e.g., received by light sources of different lanes or channels), receive optical power (e.g., optical power received by photodetectors of different lanes or channels), and/or other operating parameters. As an illustrative example in these configurations, the processing circuitry may obtain at least first historical measurement data for a first operating parameter such as transmit power and second historical measurement data for a second operating parameter such as transmit bias current.

At block 62, the processing circuitry may perform preprocessing of the historical measurement data. In particular, the historical measurement data for different operating parameters obtained at block 60 may be in different forms (e.g., in different units), may have different distributions (e.g., having different range of values), may be on different scales (e.g., a logarithmic scale, a linear scale, etc.), and/or may be generally not be comparable with one another (e.g., may not be conducive to the desired processing at subsequent blocks 64, 66, etc.). Because the historical measurement data for different operating parameters may be used collectively to determine a degradation for the component, it may be desirable to process the historical measurement data such that the historical measurement data for different operating parameters are comparable with one another.

As examples, the preprocessing of the historical measurement data may include unit conversion (e.g., from a logarithmic scale unit such as decibel-milliwatts (dBm) to a linear scale unit such as milliwatt (mW)), data set normalization (e.g., a standard score normalization for the historical measurement data of each operating parameter), and/or other preprocessing operations.

At block 64, the processing circuitry may determine operating parameter(s) that define a (natural) degradation of the component type. In some illustrative configurations described herein, a first operating parameter may serve as a primary parameter that corresponds to the degradation of the component, while one or more additional operating parameters serve as biasing parameter(s) that induces changes (e.g., biases) in the primary parameter. By removing the bias(es) caused by the biasing parameter(s) from the primary parameter, a (natural) degradation of the component type can be determined.

For example, FIG. 5 shows three illustrative graphs of two sets of historical measurement data for a device component and a set of component (natural) degradation data obtained by the processing circuitry (e.g., processing circuitry 32 or other processing implementing system 20). In the example FIG. 5, a first graph 74 shows illustrative measurement data values for a primary operating parameter of the component. The primary parameter data values, as obtained and preprocessed by the processing circuitry (e.g., at block 62), may include one or more biases caused by other operating parameter(s) of the component such as a biasing parameter having measurement data values (e.g., preprocessed measurement data values provided from block 62 in FIG. 4) shown in second graph 76. Accordingly, the processing circuitry may remove, from the primary parameter data values, the bias caused by the biasing parameter data values to obtain (e.g., generate) the component degradation data values shown in graph 78. The component degradation data in graph 78 may sometimes be referred to herein still as historical measurement data (e.g., historical measurement data for the primary parameter, with bias(es) removed).

As one example, to generate the component degradation data (e.g., as part of the operations at block 64), the processing circuitry may scale the biasing parameter data values by a scaling factor (e.g., a negative scaling factor) and add the scaled biasing parameter data values to the primary parameter data values. The scaling factor may be determined by performing a regression analysis (e.g., a regression fit) on a dataset of primary parameter data values and biasing parameter data values for the set of components of the same type. The scaling factor may be the regression parameter determined by the regression analysis. The regression analysis may help determine the general correlation between the primary parameter and the biasing parameter and consequently the scaling factor used to remove the effect of the biasing parameter on the primary parameter. While a scaling factor being applied to the biasing parameter is sufficient to describe the biasing effect in this example, this is merely illustrative. If desired, more complex adjustments may be applied to the biasing parameter to describe the biasing effect and/or may be used to remove the effect of the biasing parameter on the primary parameter. The scaling factor may be component-type-specific and may therefore be different, depending on the relationship between operating parameters for different component types.

While a single primary operating parameter and a single biasing operating parameter is shown in and described in connection with the example of FIG. 5 to define a (natural) component degradation. This is merely illustrative. In general, any suitable number of primary and biasing parameter(s) may characterize component degradation. The number and types of operating parameters characterizing component degradation and their relationships with respect to each other may be based on the component type and component operations.

In illustrative configurations in which the operating parameters are for an optical transceiver of the type of transceiver 12 (or an optical transceiver module of the type of module 52), the primary parameter shown in graph 74 may be the transmit optical power of the optical transceiver and the biasing parameter shown in graph 76 may be the transmit bias current of the optical transceiver. If desired, other operating parameters of an optical transceiver be used as the primary parameter and/or the biasing parameter, instead of or in addition to transmit optical power and/or transmit bias current. As an example, temperature may be used as an additional biasing parameter, whose biasing effect on transmit optical power should be removed from the transmit optical power to derive the (natural) optical transceiver degradation.

The operations described in connection with FIG. 5 may be performed as part of block 64. Referring back to FIG. 4, at block 66, the processing circuitry may perform regression analysis on component degradation data, or historical measurement data with bias(es) removed, (e.g., the degradation data shown in graph 78 of FIG. 5) to obtain regression parameter value(s) that define degradation behavior. In particular, the processing circuitry may perform a linear regression fit on the degradation data values (e.g., the measurement data values with bias(es) or biasing effect(s) removed) to determine a value for a regression parameter (e.g., the coefficient indicative of a slope of linear trend) that characterizes degradation behavior (e.g., describing how the component degrades over time).

Using graph 78 in FIG. 5 as an example, the processing circuitry may perform a regression analysis (e.g., a linear regression fit) on the component degradation data values in graph 78 (e.g., obtained by removing the effect of biasing parameter data values from the primary parameter data values). The regression analysis may generate a regression parameter value describing the trend of the degradation data values over time. In this example, the regression parameter may be the slope of line 80 (e.g., a trend line for degradation data).

The example of FIG. 5 shows data values (e.g., in graphs 74, 76, and 78) for a given component (e.g., optical transceiver 12, or optical transceiver module 52) that is operating normally. The processing circuitry may determine that the degradation behavior of the given component is natural or normal when comparing its behavior collectively with degradation behavior of other components of the same type, whose historical measurement data undergoes the same types of processing as described in connection with FIG. 5. As described above, normally operating components of the same type tend to degrade in a similar manner over their lifetimes. Accordingly, the slopes of trendlines characterizing the (natural) degradation of these components should fall within a range of acceptable slopes. In the example of FIG. 5, line 80 (e.g., the slope of line 80) may have a relatively small negative slope (or for some types of components, a slope of zero).

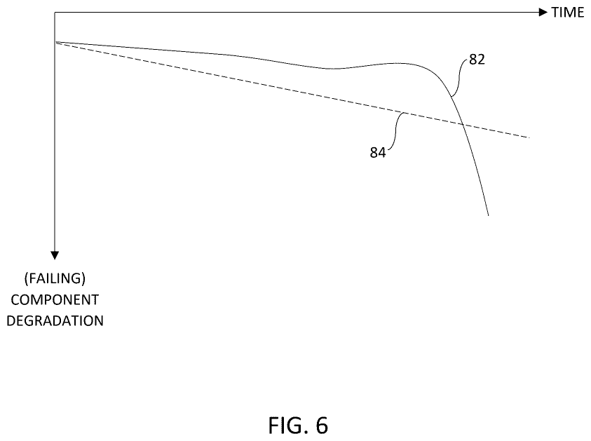

An illustrative example of degradation data for a failing component (e.g., a component predicted to experience failure, of the same type as the component described in connection with FIG. 5) is shown in FIG. 6. The processing circuitry may perform the same operations of blocks 60, 62, and 64 in FIG. 4 (e.g., the operations described in connection with FIG. 5) for the measurement data of this failing component as the normally operating component of FIG. 5. In other words, the processing circuitry may obtain historical measurement data for the operating parameters (e.g., the primary operating parameter, one or more biasing parameters, etc.) of the failing component and may preprocess the historical measurement data. The processing circuitry may further generate the degradation data values 82 by removing the bias(es) from the primary parameter data values (e.g., by applying the same scaling factor as described in connection with FIG. 5 and adding the scaled biasing parameter data values to the primary parameter data values) to obtain the component degradation data values 82. Because the same types of components are described in connection with FIGS. 5 and 6, the same methodology (e.g., the same primary and/or biasing parameters, the same scaling factor(s) describing the biasing effect of biasing parameters on the primary parameter, etc.) may be used to generate the degradation data values.

Using degradation data values 82 in FIG. 6 as another example of the operations performed at block 66, the processing circuitry may perform a regression analysis (e.g., a linear regression fit) on the component degradation data values 82 in FIG. 6 (e.g., obtained by removing the effect of biasing parameter data values from the primary parameter data values). The regression analysis may generate a regression parameter value describing the trend of the degradation data values 82 over time (e.g., over the same relative lifetime period as in FIG. 5). In this example, the regression parameter may be the slope of line 84 (e.g., a trend line for degradation data values 82).

The example of FIG. 6 shows degradation data values 82 for a given component that is expected to fail (e.g., whose failure is being predicted by the processing circuitry). The processing circuitry may determine that the degradation behavior of the given component is predictive of expected failure based on line 84 (e.g., the slope of line 84) having a relatively large negative slope (e.g., a slope greater in magnitude than the magnitude of the slope of line 80 in FIG. 5, a slope greater in magnitude than a range of slopes defining a natural degradation, etc.). In other words, the processing circuitry may determine that degradation of the component indicated by the graph of FIG. 6 deviates from the natural degradation of components of the same type (e.g., at least partly indicated by the natural degradation graph of FIG. 5) to identify the component associated with FIG. 6 as a candidate for expected failure. While the approach using a single regression analysis of degradation data (e.g., historical measurement data, with biases removed) described in connection with FIGS. 5 and 6 may be satisfactory in identifying components expected to fail in some scenarios and/or for some applications, this approach may be ineffective in other scenarios and/or for other applications. As an example, when the dataset is large (e.g., spans a relatively long period of time) and degradation can occur suddenly (e.g., within a relatively short period of time), the single linear regression approach may not be as effective in predicting failure (or at least doing so with the desired amount of lead time) as the single regression over the entire dataset provides the overall trend across the entire period of time of the dataset.

Accordingly, in some illustrative configuration described herein as an example, performing the operations at block 66 in FIG. 4 may include performing the operations of block 68 in FIG. 4. In particular, at block 68, the processing circuitry may perform multiple regression analyses for different time intervals of different durations. This may be helpful in accounting for longer-term behavior(s), shorter-term behavior(s), and/or generally behavior(s) across different time scales when characterizing or defining component degradation.

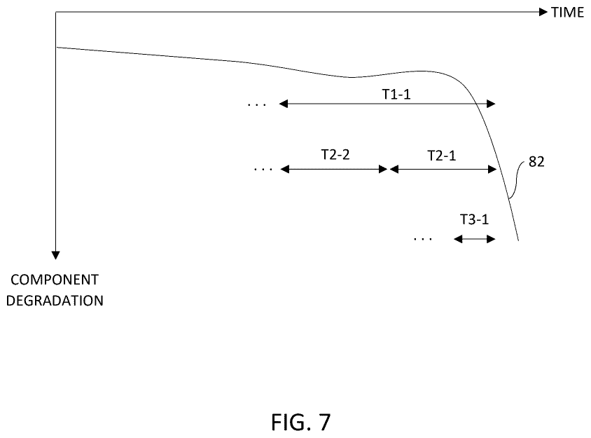

As an example, FIG. 7 shows how component degradation data 82 (e.g., the same degradation data 82 as in FIG. 6) may be analyzed (e.g., as part of the operations at block 68) by performing regression analyses (e.g., multiple linear regression fits) over different time periods of different durations. In the example of FIG. 7, the processing circuitry may perform (e.g. as part of the operations at block 68) one or more regression analyses on degradation data values 82 within one or more time periods T1, such as time period T1-1, may perform regression analyses on degradation data values 82 within one or more time periods T2, such as time periods T2-1 and T2-2, may perform regression analyses on degradation data values 82 within one or more time periods T3, such as time period T3-1, and/or may perform additional regression analyses on degradation data values 82 within any other desired time period(s).

As shown in FIG. 7, each time period T1 may have a duration greater than the duration of each time period T2. Each time period T2 may have a duration greater than the duration of each time period T3. At least some of time periods T1, T2, and T3 may temporally overlap one another. In other words, as an example, degradation data values 82 within time period T1-1 may include degradation data values 82 within time period T2-1 and include degradation data values 82 within time period T2-2; degradation data values 82 within time period T2-1 may include degradation data values 82 within time period T3-1 and include degradation data values within some additional time periods T3.

In such a manner, a regression analysis performed using degradation data values within a longer time period T1 may generate one or more regression parameter values that characterize (e.g., defines, describes, etc.) a longer-term degradation behavior. A regression analysis performed using degradation data values within a shorter time period T3 may generate one or more regression parameters that characterize (e.g., defines, describes, etc.) a shorter-term degradation behavior. A regression analysis performed using degradation data values within a medium-duration time period T2 may generate one or more regression parameters that characterize (e.g., defines, describes, etc.) a medium-term degradation behavior. Because the entire dataset of degradation data values may span multiple time periods (e.g., multiple time periods T1, multiple time periods T2, multiple time period T3, etc.), a corresponding set of one or more regression parameter values may be generated when performing a regression analysis based on each of these time periods.

The combination of these regression parameter values may define the component degradation. Accordingly, a metric of component degradation may be generated based on these regression parameters.

In illustrative configurations described herein as an example, the metric may be a degradation score. If desired, one or more other indications (e.g., another metric) of component degradation may be used instead of or in addition to the degradation score.

Referring back to FIG. 4, at block 70, the processing circuitry may generate a degradation score, for each component, based on the regression parameter value(s) for that component generated at block 68 (or generally at block 66, when the single regression analysis approach is used). In particular, because the regression parameter values may represent different behavior exhibited by different subsets of degradation data values, different weights may be applied to the different regression parameter values to arrive at the degradation score. This different weighting may help provide the relative importance of the different regression parameter values to the degradation store, or more generally, to improve (e.g., the accuracy of, the reliability of, etc.) the determination of whether degradation of a given component is natural or abnormal (e.g., deviates from a natural degradation).

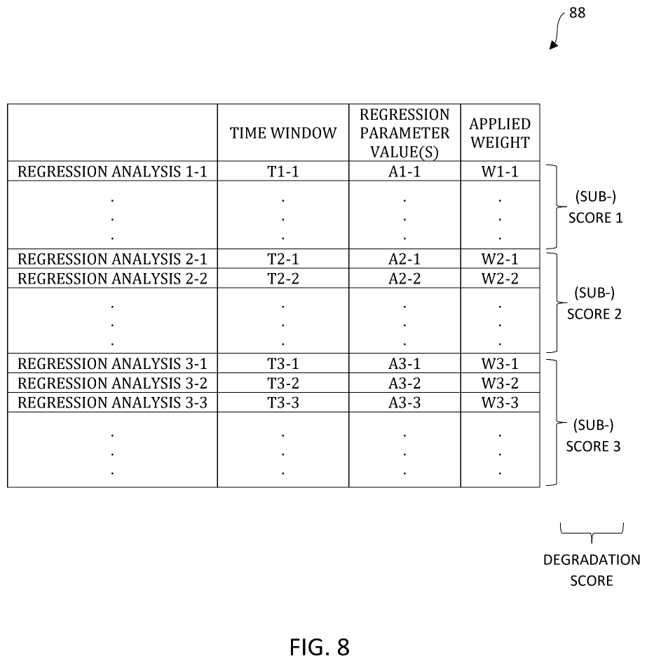

As an example, FIG. 8 is a diagram of regression parameter values determined by the processing circuitry based on the regression analyses performed on the degradation data values 82 (e.g., as described in connection with FIG. 7 and block 68 of FIG. 4). As shown in table 88 of FIG. 8, each regression analysis performed on the degradation data values may be performed for a particular time period (e.g., using the subset of degradation data values 82 within the particular time period) and may determine a regression parameter value (and additional regression parameter value(s) depending on the number of regression parameters). The processing circuitry may also associate a predetermined weight with each regression parameter value such that each regression parameter value is weighted appropriately when generating the overall degradation score.

In the example of FIG. 8 (e.g., as previously described in connection with FIG. 7), the processing circuitry may perform regression analysis 1-1 on the degradation data values within time period T1-1 to generate a regression parameter value A1-1, and if desired, may generally perform additional regression analyses on the degradation data values within additional time periods T1 (of the same duration as time period T1-1) to generate respective regression parameter values for those additional time periods T1. The processing circuitry may perform regression analysis 2-1 on the degradation data values within time period T2-1 to generate a regression parameter value A2-1, may perform regression analysis 2-2 on the degradation data values within time period T2-2 to generate a regression parameter value A2-2, and if desired, may generally perform additional regression analyses on the degradation data values within additional time periods T2 (of the same duration as time periods T2-1 and T2-2) to generate respective regression parameter values for those additional time periods T2. The processing circuitry may perform regression analysis 3-1 on the degradation data values within time period T3-1 to generate a regression parameter value A3-1, may perform regression analysis 3-2 on the degradation data values within time period T3-2 to generate a regression parameter value A3-2, may perform regression analysis 3-3 on the degradation data values within time period T3-3 to generate a regression parameter value A3-3, and if desired, may generally perform additional regression analyses on the degradation data values within additional time periods T3 (of the same duration as time periods T3-1, T3-2, and T3-3) to generate respective regression parameter values for those additional time periods T3.

The processing circuitry may further determine weights to be applied to the regression parameter values. As an example, these weights may be selected based on the component type and/or to enhance component failure prediction.

As shown in FIG. 8, a set of weights W1 may be applied to a corresponding set of regression parameters A1 (e.g., each generated over a corresponding time period T1). In particular, a weight W1-1 may be applied to regression parameter value A1-1. A set of weights W2 may be applied to a corresponding set of regression parameters A2 (e.g., each generated over a corresponding time period T2). In particular, a weight W2-1 may be applied to regression parameter value A2-1, a weight W2-2 may be applied to regression parameter value A2-2, etc. A set of weights W3 may be applied to a corresponding set of regression parameters A3 (e.g., each generated over a corresponding time period T3). In particular, a weight W3-1 may be applied to regression parameter value A3-1, a weight W3-2 may be applied to regression parameter value A3-2, a weight W3-3 may be applied to regression parameter value A3-3, etc.

In some illustrative configurations described herein as an example, the weights for the regression parameters generated based on time periods of the same duration may be interdependent (e.g., generated based on the same hyperparameter). As a specific example, weights W2-1, W2-2, and other weights W2 for regression parameter values for other time periods T2 may each be generated using the same selected hyperparameter value. Similarly, weights W3-1, W3-2, W3-3, and other weights W3 for regression parameter values for other time periods T3 may each be generated using the same selected hyperparameter value. The hyperparameter value based on which a first set of weights (e.g., weights W2) are generated may be different from (or if desired, may be the same as) the hyperparameter value based on which a second set of weights (e.g., weights W3) are generated.

To enhance component failure prediction capability using the weights, the processing circuitry may more heavily weigh regression parameter values that have a greater tendency to be predictive of future failure. As an example, regression parameter values generated based on regression analysis of more recent degradation data is applied with a greater weight relative to regression parameter values generated based on regression analysis of less recent degradation data. Accordingly, using weights W2 as an example, although weights W2 may all be generated using the same selected hyperparameter value, the function that is used to derive each of the weights W2 based on the same hyperparameter value may be different from each other. Accordingly, these functions may cause weight W2-1 (e.g., being applied to a regression parameter value derived from the more recent time period of data) to be greater than weight W2-2 (e.g., being applied to a regression parameter value derived from the less recent time period of data).

The weighted regression parameter values may then be combined to generate the overall degradation score for the analyzed component. In the example of FIG. 8, if desired, sub-scores may be generated based on the regression parameter value(s) from regression analyses based on time period(s) of the same duration. In particular, the processing circuitry may determine a first sub-score based on (e.g., by summing the weighted versions of) regression parameter values A1 (e.g., value A1-1), a second sub-score based on (e.g., by summing the weighted versions of) the regression parameter values A2 (e.g., values A2-1 and A2-2), a third sub-score based on (e.g., by summing the weighted versions of) the regression parameter values A3 (e.g., values A3-1, A3-2, and A3-3), and/or any other sub-scores based on regression parameter value(s) from regression analyses based on other time period(s) of the same duration.

Each of these sub-scores may be indicative of degradation behavior at different time scales. In the example of FIG. 8, the first sub-score (based on values A1) may be indicative of a long-term degradation behavior (e.g., because time periods T1 has the greatest duration), the third sub-score (based on values A3) may be indicative of a short-term degradation behavior (e.g., because time periods T3 has the smallest duration), and the second sub-score (based on values A2) may be indicative of a medium-term degradation behavior (e.g., because time periods T3 has the middling duration).

The processing circuitry may determine the degradation score by incorporating each of the sub-scores, thereby incorporating short-term behavior, long-term behavior, and medium-term behavior into the degradation score. In one illustrative arrangement, the degradation score may be the sum of the sub-scores.

The examples of FIGS. 7 and 8 are merely illustrative. While three illustrative time intervals (e.g., corresponding to time periods T1, T2, and T3) are used for regression analyses, this is merely illustrative. If desired, any suitable number of time intervals of any suitable set of durations may be used. While not explicitly described in connection with FIGS. 7 and 8, the processing circuitry may perform the operations described in connection with FIGS. 7 and 8 for each of the components of the same type (and for which sufficient historical measurement data is obtained). Accordingly, the same sets of regression analyses (e.g., based on the same sets of time periods) may be performed for the degradation data values (e.g., operating parameter data values with biases removed) of each of these components, and the same weights may be applied to the (different) regression parameter values generated based on the analyses of different components.

Accordingly, (e.g., in connection with block 70), the processing circuitry may generate a degradation score for each of the components of the same type. Referring back to FIG. 4, at block 72, the processing circuitry may identify any components that are expected to fail based on their corresponding degradation scores. In particular, the degradation scores of components of the same type may mostly fall within a given range of degradation scores indicative of a natural degradation of the component type. Accordingly, the processing circuitry may identify components whose degradation scores are outside of that range.

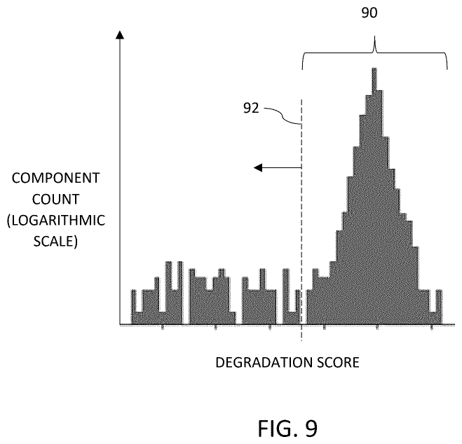

As an example, FIG. 9 shows a histogram of a distribution of degradation scores for components of the same type (e.g., each of the degradation scores being generated based on the operations described in connection with FIGS. 7 and 8). As shown in FIG. 9, a range of degradation scores 90 may be indicative of a natural degradation of components of the component type. Accordingly, the processing circuitry (e.g., as part of the operations of block 72) may determine a threshold such as a threshold degradation score value 92, serving as a criterion based on which the processing circuitry can identify components that are expected to fail. The criterion may be satisfied or met when the identified components have degradation scores exceeding (e.g., less than) the threshold degradation value 92 (e.g., a lower threshold value or a floor value). In general, a degradation score of a component that exceeds (e.g., is outside of) the threshold limit(s) (e.g., upper and/or lower limits set by corresponding upper (ceiling) and/or lower (floor) threshold values) for degradation scores may be indicative of the component being expected to fail. If desired, other criteria may be used, additionally or alternatively, to identify components as candidates for expected failure.

In illustrative configurations described herein as an example, the operations at blocks 60, 62, 64, 66, 68, and 70 in FIG. 4 may be performed at block 54 in FIG. 3, and the operations at block 72 in FIG. 4 may be performed at block 56 in FIG. 3. Accordingly, after identifying any components that are expected to fail at block 72 in FIG. 4, the processing circuitry may mitigate the expected failure of these identified components in the manner described in connection with block 58 in FIG. 3.

While linear regression is sometimes described herein as being performed as part of regression analysis, this is merely illustrative. If desired, any desired types of regression analysis may be performed generally to determine value(s) of regression parameter(s) that describe a relationship (e.g., degradation behavior) between independent variable(s) (e.g., time) and dependent variable(s) (e.g., operating parameters, with biases removed).

The methods and operations described above in connection with FIGS. 1-9 may be performed by the components of one or more network devices and/or one or more servers or other host equipment in a network using software, firmware, and/or hardware. Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server(s) or other host equipment (e.g., processing circuitry of network devices, compute devices of server equipment, processing circuitry of computing devices, etc.).

The foregoing is merely illustrative and various modifications can be made to the described embodiments. The foregoing embodiments may be implemented individually or in any combination.

What is claimed is:

1. A component failure prediction system comprising:
memory circuitry; and
processing circuitry communicatively coupled to the memory circuitry and configured to:
obtain historical measurement data for a plurality of network device components of a same type;
determine degradation of each of the plurality of network device components based on the historical measurement data, wherein the degradation of at least some of the plurality of network devices defines a natural degradation;
identify a given network device component of the plurality of network device components based on the degradation of the given network device component deviating from the natural degradation; and
mitigate an expected failure of the identified given network device component.

2. The component failure prediction system defined in claim 1, wherein the processing circuitry is configured to determine the degradation of each of the plurality of network device components by:
determining a first degradation behavior of the given network device component across a first set of one or more time periods, each of a first duration; and
determining a second degradation behavior of the given network device component across a second set of one or more time periods, each of a second duration, wherein the degradation of the given network device component is at least partly defined by the first and second degradation behaviors.

3. The component failure prediction system defined in claim 2, wherein the first degradation behavior is determined by performing a first regression analysis on the historical measurement data for the given network device component within a given time period of the first set of one or more time periods and wherein the second degradation behavior is determined by performing a second regression analysis on the historical measurement data for the given network device component within a given time period of the second set of one or more time periods.

4. The component failure prediction system defined in claim 3, wherein the historical measurement data for the given network device component comprises first measurement data for a first operating parameter and second measurement data for a second operating parameter and wherein the processing circuitry is configured to determine the first and second degradation behaviors by:
prior to performing the first and second regression analyses,
adjusting at least one of the first measurement data or the second measurement data to be comparable with the other one of the first measurement data or the second measurement data; and
removing an effect of the second measurement data on the first measurement data, wherein the first measurement data, with the effect of the second measurement data removed, is used to perform the first and second regression analyses.

5. The component failure prediction system defined in claim 2, wherein the processing circuitry is configured to determine the degradation of each of the plurality of network device components by:
determining a third degradation behavior of the given network device component across a third set of one or more time periods, each of a third duration, wherein the degradation of the given network device component is at least partly defined by the third degradation behavior and wherein the historical measurement data for the given network device component is analyzed using the first, second, and third sets of one or more time periods to determine the first, second, and third degradation behaviors, respectively.

6. The component failure prediction system defined in claim 1, wherein the degradation of each of the plurality of network device components is represented by a corresponding score and wherein the natural degradation is represented by a range of scores.

7. The component failure prediction system defined in claim 6, wherein the given network device component is identified by the score of the given network device component exceeding the range of scores.

8. The component failure prediction system defined in claim 1, wherein the plurality of network device components of the same type comprise a plurality of optical transceivers.

9. The component failure prediction system defined in claim 8, wherein the historical measurement data for the plurality of network device components comprises historical measurement data of transmit optical power and of transmit bias current for the plurality of optical transceivers.

10. The component failure prediction system defined in claim 8, wherein the plurality of optical transceivers are in a same type of pluggable optical transceiver module.

11. The component failure prediction system defined in claim 1, wherein the processing circuitry is configured to mitigate the expected failure of the identified given network device component by providing a notification that contains an indication of the given network device component and the expected failure of the given network device component.

12. The component failure prediction system defined in claim 1, wherein the processing circuitry is configured to mitigate the expected failure of the identified given network device component by storing, on the memory circuitry, information indicative of the degradation of the given network device component deviating from the natural degradation for access by external equipment.

13. A method of monitoring an optical transceiver, the method comprising:
obtaining first historical measurement data on a first operating parameter of the optical transceiver, the first operating parameter being a transmit optical power;
obtaining second historical measurement data on a second operating parameter of the optical transceiver;
determining, based on the first and second historical measurement data, degradation of the optical transceiver; and
based on the degradation of the optical transceiver satisfying a criterion, issuing a notification identifying the optical transceiver as a candidate for anticipated failure.

14. The method defined in claim 13, wherein determining the degradation of the optical transceiver comprises:
adjusting at least one of the first historical measurement data or the second historical measurement data to be comparable with the other one of the first historical measurement data or the second historical measurement data; and
adjusting the first historical measurement data to remove a bias caused by the second historical measurement data.

15. The method defined in claim 14, wherein determining the degradation of the optical transceiver comprises:
performing a regression analysis using the first historical measurement data, adjusted to remove the bias caused by the second historical measurement data, to determine a regression parameter that at least partly characterizes the degradation of the optical transceiver.

16. The method defined in claim 15, wherein the second operating parameter is a transmit bias current.

17. A component failure prediction system comprising:
memory circuitry; and
processing circuitry coupled to memory circuitry and configured to:
obtain historical measurement data for each of a plurality of device components that are of the same component type;
obtain a corresponding degradation score for each of the plurality of device components based on the historical measurement data, wherein the corresponding degradation score for a given device component of the plurality of device components is at least partly defined by a long-term behavior of the given device component over a first time period having a first duration and at least partly defined by a short-term behavior of the given device component over a second time period having a second duration less than the first duration;
compare the degradation score of the given device component to a threshold indicated by the degradation scores of at least some additional device components of the plurality of device components; and
mitigate an anticipated failure of the given device component in response to the degradation score of the given device component exceeding the threshold.

18. The component failure prediction system defined in claim 17, wherein the processing circuitry is configured to determine the long-term behavior of the given device component by performing a first regression analysis using the historical measurement data, over the first time period, for the given device component to determine a first regression parameter value and is configured to determine the short-term behavior of the given device component by performing a second regression analysis using the historical measurement data, over the second time period, for the given device component to determine a second regression parameter value and wherein the processing circuitry is configured to obtain the degradation score for the given device component using the first and second regression parameter values.

19. The component failure prediction system defined in claim 18, wherein the short-term behavior is characterized by a behavior of the given device component over a third time period having the second duration, wherein the processing circuitry is configured to determine the short-term behavior of the given device component by performing a third regression analysis using the historical measurement data, over the third time period, for the given device component to determine a third regression parameter value, and wherein the processing circuitry is configured to obtain the degradation score for the given device component using the third regression parameter value.

20. The component failure prediction system defined in claim 19, wherein the third time period is more recent than the second time period and wherein the processing circuitry is configured to obtain the degradation score for the given device component by applying a first weight value to the second regression parameter value and by applying a second weight value, greater than the first weight value, to the third regression parameter value.
